(19) United States
(12) Patent Application Publication
(10) Pub. No.: US 2014/0102755 A1
(43) Pub. Date: Apr. 17, 2014

(54) Communications Cables Having Electrically Insulative but Thermally Conductive Cable Jackets

(71) Applicant: CommScope, Inc. of North Carolina, Hickory, NC (US)

(72) Inventor: Luc Walter Adriaenssens, Frisco, TX (US)

(21) Appl. No.: 14/052,907

(22) Filed: Oct. 14, 2013

Related U.S. Application Data
(60) Provisional application No. 61/714,985, filed on Oct. 17, 2012.

(51) Int. Cl. H01B 11/18; H01B 11/02

(52) U.S. Cl. CPC H01B 11/1895; H01B 11/02
USPC 174/113 R

(57) ABSTRACT

A communications cable includes a plurality of insulated conductors that are arranged as at least four twisted pairs of insulated conductors and a cable jacket that surrounds the at least four twisted pairs of insulated conductors, the cable jacket including an outer surface that defines the exterior surface of the communications cable. The cable jacket may be a thermally conductive cable jacket.

### CROSS-REFERENCE TO RELATED APPLICATION

The present application claims priority under 35 U.S.C. §119 to U.S. Provisional Application Ser. No. 61/714,985, filed Oct. 17, 2012, the entire content of which is incorporated herein by reference as if set forth in its entirety.

### FIELD OF THE INVENTION

The present invention relates generally to communications cables and, more particularly, to jacketed communications cables that may be bundled together with other communications cables into cable bundles.

### BACKGROUND

A wide variety of communications cables are known in the art including, for example, coaxial cables and twisted pair communications cables. Coaxial cables are used in applications such as cable television networks, cellular telephone networks and the like. Typically a coaxial cable includes a center conductor, a dielectric layer that surrounds the center conductor, an outer conductor that surrounds the dielectric layer, and an insulative cable jacket that surrounds the outer conductor. The insulative cable may protect the cable from dirt, debris, physical damage, water ingress, moisture, etc. The outer conductor may comprise a solid metal cylinder or braided wires. Additional layers or elements such as shielding tapes may also be included in the cable.

Twisted pair cables are also well known in the art, and include unshielded twisted pair (“UTP”) cables and foil twisted pair (“FTP”) cables. These cables are commonly used in local area networks and various other applications and are often referred to as “Ethernet” cables. Typically, a twisted pair cable includes a plurality of insulated conductors. Each insulated conductor is twisted together with another of the insulated conductors to form a plurality of twisted pairs of conductors. The twisted pairs of conductors may then be twisted together in a core twist. An insulative cable jacket is provided that surrounds all of the twisted pairs of conductors. A tape, cruciform or other separator may be provided in the interior of the cable that separates at least one of the twisted pairs from at least one other of the twisted pairs. With FTP cables, a shield such as a thin aluminum foil (possibly with a mylar or other polyester backing) is provided within the cable jacket to surround the plurality of twisted pairs. In some case each twisted pair within the cable may include its own shield instead of or in addition to, a shield that surrounds all of the twisted pairs.

A plurality of communications cables such as coaxial cables or twisted pair cables are routinely bundled together into cable bundles using, for example, plastic bands, cable ties, twist ties or other cable management devices. These cable bundles may then be routed through cable troughs, conduits, false floors, walls, ceilings and the like. The close proximity of the cables within a cable bundle can cause a variety of problems as the close proximity of the cables can negatively impact performance characteristics of the cable bundle.

### SUMMARY

Pursuant to embodiments of the present invention, communications cables are provided that have a plurality of insulated conductors that are arranged as four twisted pairs of insulated conductors. A cable jacket surrounds the four twisted pairs of insulated conductors. The cable jacket has an outer surface that defines the exterior surface of the communications cable. The cable jacket is a thermally conductive cable jacket.

In some embodiments, at least some of the insulated conductors comprise an elongated metal wire having a plurality of carbon nanotubes at an exterior surface thereof. The cable jacket may be formed of an insulative material that has thermally conductive materials embedded therein. The communications cable may be bundled together with a plurality of additional communications cables in a communications cable bundle. Moreover, the communications cable may include a conductive shield that at least partially surrounds one or more of the twisted pairs of insulated conductors.

In some embodiments, the cable jacket may have a thermal conductivity of at least 1 Watt per meter-Kelvin. The conductors may have a diameter that is no greater than 21 millimeters. The metal wire may be a copper wire, a copper alloy wire, a copper plated wire or a copper alloy plated wire. The axial direction of a majority of the carbon nanotubes may be generally aligned with a longitudinal axis of the elongated metal wire. The cable may also include a thermally conductive separator that separates at least a first the twisted pairs of insulated conductors from a second of the twisted pairs of insulated conductors. The insulation on at least some of the insulated conductors may comprise thermally conductive insulation.

Pursuant to embodiments of the present invention, communications cables are provided that have at least one metal conductor that includes carbon nanotubes and a thermally conductive cable jacket that surrounds the at least one metal conductor and that defines the exterior surface of the communications cable.

In some embodiments, the at least one metal conductor may be the center conductor of a coaxial cable, and the communications cable may further include a dielectric layer that surrounds the center conductor and an outer conductor that surrounds the dielectric layer, the outer conductor being within the thermally conductive cable jacket. The outer conductor may be an elongated hollow metal wire having a plurality of carbon nanotubes adjacent an exposed surface thereof. The dielectric layer may include thermally conductive particles embedded therein. The thermally conductive cable jacket may be electrically insulative.

Pursuant to embodiments of the present invention, communications cables are provided that have a plurality of insulated conductors that are arranged as four twisted pairs of insulated conductors. A thermally conductive and electrically insulative cable jacket surrounds the four twisted pairs of insulated conductors, the cable jacket including an outer surface that defines the exterior surface of the communications cable. The cable further includes a thermally conductive separator that separates at least a first the twisted pairs of insulated conductors from a second of the twisted pairs of insulated conductors.

In some embodiments, the insulation on at least some of the insulated conductors comprise thermally conductive insulation. At least some of the insulated conductors may comprise elongated metal wires that have a plurality of carbon nanotubes at an exterior surface thereof. The communications cable may be bundled together with a plurality of additional communications cables in a communications cable bundle. The communications cable may be in combination with a direct current power source that is configured to provide a power-over-Ethernet direct current power signal to at least a first of the insulated conductors.

### BRIEF DESCRIPTION OF THE DRAWINGS

FIG. 1 is a perspective view of a small portion of a twisted pair communications cable according to embodiments of the present invention, where a cable jacket of the cable has been partially removed to show the four twisted pairs of conductors and the separator that are included in the cable.

FIG. 2 is an enlarged, fragmentary, side view of the cable of FIG. 1 with a portion of the jacket removed to show the twisted core of the cable.

FIG. 3 is a cross-sectional view of one of the insulated conductors of the twisted pair cable of FIG. 1.

FIG. 4 is a side view of a coaxial cable according to embodiments of the present invention.

FIG. 5 is a schematic perspective view of the outer conductor of the communications cable of FIG. 4 that illustrates how carbon nanotubes can be embedded within a surface of the outer conductor.

FIG. 6 is a schematic cross-sectional view of a cable bundle that includes cables according to embodiments of the present invention.

FIG. 7 is schematic diagram illustrating a Power-over-Ethernet arrangement in which a device is powered via a direct current signal provided over a twisted pair cable according to embodiments of the present invention.

### DETAILED DESCRIPTION

Pursuant to embodiments of the present invention, communications cables are provided that have thermally conductive cable jackets. These thermally conductive cable jackets may be used to more efficiently dissipate heat that may build up in the interior of the cable, particularly when the cable is in an interior position within a cable bundle. In some embodiments, the communications cable may comprise a twisted pair communications cable that includes a plurality of twisted pairs of insulated conductors. The conductors may comprise a metal wire such as a copper, aluminum, or steel wire, or an alloy thereof, and may further include carbon nanotubes that are embedded or otherwise included in at least an outer portion of the metal wire to provide a substantially enhanced conductivity conductor.

In some embodiments, the carbon nanotubes that are included in the conductors may reduce the attenuation that high frequency signals experience when traversing the communications cable. Based on this reduced attenuation, it is possible to reduce the diameter of each conductor in the cable, thereby reducing the size and weight of the cable, as well as the amount of metal, conductor sheathing material, cable jacketing material, etc. required to manufacture the cable. However, the use of smaller diameter conductors may increase the resistance of the cable to direct current and low frequency signals. This increased resistance may cause the conductors of the cable to generate excessive heat when passing direct current or low frequency signals such as a Power-Over-Ethernet power signal, and this temperature increase can negatively affect various performance characteristics of the cable.

Pursuant to embodiments of the present invention, specialized cable jackets are provided that are made of or include thermally conductive materials that better dissipate heat from the interior of the cable. These cable jackets may reduce the amount of heat that builds up in communications cables such as cables that use small diameter conductors that are more prone to heating. In some embodiments, the cable jackets may comprise an insulative material such as a plastic or the like that has thermally conductive particles dispersed or otherwise embedded therein. The inclusion of these particles may increase the thermal conductivity of a conventional cable jacket by a factor of two, or five, or ten, one hundred or even five hundred or more. Consequently, even if the communications cables according to embodiments of the present invention are bundled together in cable bundles, the tendency of cables that are located in the interior of the bundle to overheat, particularly when carrying direct current or low frequency signals, may be significantly reduced. These same techniques may be used on other types of communications cables including, for example coaxial cables, hybrid fiber-coaxial cables, etc.

Pursuant to further embodiments of the present invention, other components of a communications cable may alternatively or additionally include thermally conductive materials. By way of example, twisted pair communications cables routinely include separator structures such as cruciform separators or separator tapes that separate one or more twisted pairs from one or more additional twisted pairs. These separator structures are typically made of an insulative material that does not exhibit good thermal conductivity properties (e.g., thermal conductivity of 0.25 Watts/meter-Kelvin or less). Pursuant to embodiments of the present invention, separator structures that include or are constructed from thermally conductive materials may be used to provide thermally conductive separators. As another example, in a twisted pair cable, each conductor includes an insulative sheath that electrically isolates the conductor from the other conductors within the cable. Pursuant to further embodiments of the present invention, these sheaths may include thermally conductive materials to facilitate heat transfer from the conductive core of the conductor to outside of the cable jacket.

Embodiments of the present invention will now be discussed in more detail with reference to the drawings, which illustrate example embodiments of the present invention. In the present application, the term “cable jacket” refers to an elongated tubular material that surrounds the conductor(s) of a communications cable and has an outer surface that is the exterior surface of the communications cable. Typically, the cable jacket is electrically insulative. Additionally, the term “thermally conductive” is used herein to refer to an element (e.g., a cable jacket) that has a thermal conductivity of about 1.0 Watts/meter-Kelvin or more. In some embodiments, even higher thermal conductivity levels of at least 2.0 Watts/meter-Kelvin (or much higher) may be provided. Also, it will be appreciated that coatings such as non-stick coatings that provide improved lubrication may be applied to the exterior surface of the cable jacket. As used herein, references to the exterior surface of a communications cable refer to the outer surface of the communications jacket even in cases where a coating is provided on the outer surface of the cable jacket.

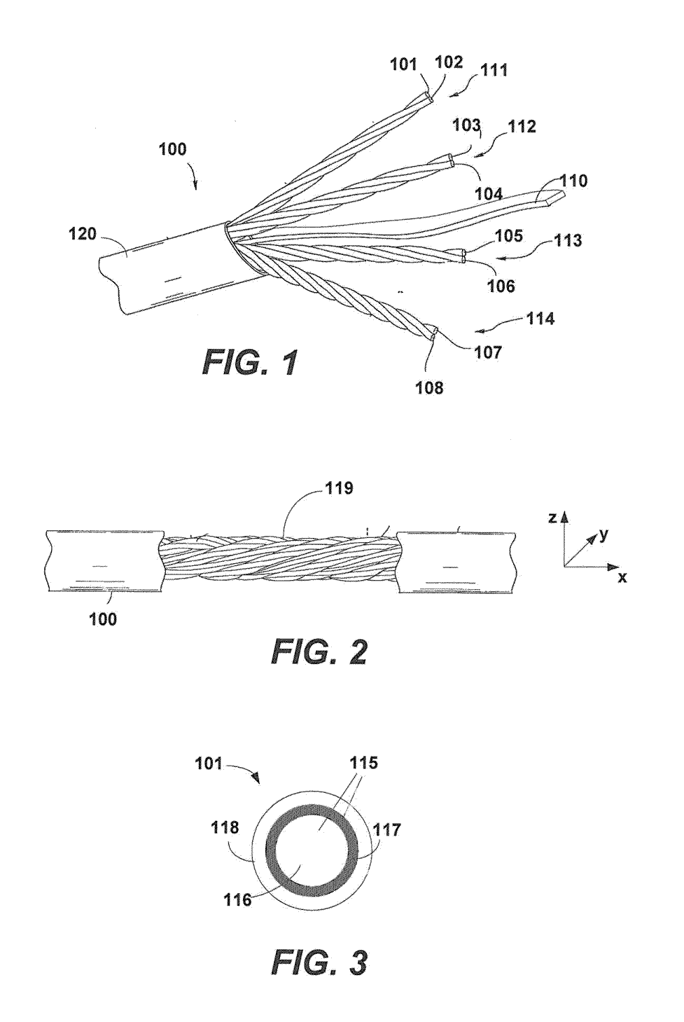

FIG. 1 is a perspective view of a small end portion of a twisted pair cable 100 according to embodiments of the present invention. In FIG. 1, the very end portion of the cable jacket of the cable has been removed to show the four twisted pairs of conductors and an optional separator that are included in the cable 100. FIG. 2 is an enlarged, fragmentary, side view of the cable 100 of FIG. 1 with a portion of the cable jacket removed. FIG. 3 is a cross-sectional view of one of the insulated conductors of the twisted pair cable 100.

As shown in FIGS. 1-3, the cable 100 includes a total of eight conductors 101- 108 that are arranged as four twisted pairs of conductors 111, 112, 113, 114. As shown in FIGS. 1 and 3 with respect to conductor 101, each conductor 101-108 may comprise an elongated conductive core 115 and an outer insulative sheath 118 that surrounds the conductive core 115. Each of the conductors 101-108 in the twisted pair cable 100 may be similar. However, in some embodiments, the diameter of the conductors 101-108 may vary. For example, the two conductors 101-108 of each twisted pair 111-114 may have the same diameter, which diameter differs from the diameters of the conductors 101-108 of the other three twisted pairs 111-114. Also, the color of the outer insulative sheath of some of the conductors 101-108 may be varied to allow an installer to distinguish between the different twisted pairs 111-114 included in the cable 100. A separator such as a separator tape or flute 110 may be included that separates at least some of the twisted pairs 111-114 from other of the twisted pairs 111-114. The twisted pairs 111-114 may be twisted together to provide a core twist 119, as is readily apparent from FIG. 2. The twisted core 119 including twisted pairs 111-114 and separator 110 may be enclosed in a cable jacket 120. One or more of the twisted pairs 111-114 may be wrapped in a foil shield (not shown). Similarly, the twisted core 119 may be wrapped in a foil shield and/or covered by a metallic braid (not shown). This twisted core foil shield may be positioned between the outer surface of the twisted core 119 and the inner surface of the cable jacket 120, and may completely surround the twisted core 119.

As shown in FIG. 3, each conductor 101-108 includes a conductive core 115 and an insulative sheath 118. In some embodiments, the conductive core 115 of each of the conductors 101-108 may comprise a metal wire and may further include carbon nanotubes that are embedded or otherwise included in at least an outer portion of the metal to provide a super- high conductivity conductor. By way of example, as shown in FIG. 3, the conductive core 115 of conductor 101 may comprise an elongated metal wire 116 that has a surface coating or plating 117. This surface coating/plating 117 may comprise, for example, a plurality of carbon nanotubes, or may comprise a metal tape or layer that is welded, plated or otherwise bonded to an outside surface of the metal wire 116 that includes a large number of carbon nanotubes.

As is known to those of skill in the art, carbon nanotubes are structural bodies formed of carbon atoms that may have a generally cylindrical shape. The diameter of the cylindrical structure may be on the order of, for example, a few nanometers to a few hundred nanometers, while the length of the cylindrical structure may be much larger such as, for example, thousands or millions of times the diameter (e.g., tens or hundreds of microns). Carbon nanotubes may exhibit unique electrical properties, including electrical conductivity along the length of the carbon nanotube that may be 1000 times greater than the electrical conductivity of copper for the same area (or volume). Carbon nanotubes are commercially available in large quantities from a variety of sources including, for example, Mitsui & Co., Ltd. (Tokyo, Japan) and Bayer AG (Leverkusen, Germany).

For high frequency communications, nearly all of the energy of an electrical signal will travel on or about the surface of an electrical conductor due to a phenomena known as the “skin effect” that is caused by eddy currents that are generated by the alternating current characteristic of the high frequency signal. As high frequency electrical signals flow primarily in only a small portion of a metal conductor (namely the outer surface(s)), the effective resistance of the conductor may be significantly increased since nearly all of the current must flow through a small portion of the conductor.

As discussed above, each of the conductors 101408 may comprise a metal wire 116 that has a carbon nanotube enhanced coating or plating 117 on, for example, an exterior surface thereof. In some embodiments, the metal core 116 may comprise a copper wire, a copper alloy wire, a copper plated wire (e.g., a copper plated aluminum wire) or a copper alloy plated wire (e.g., an aluminum wire plated with a copper alloy). The coating or plating 117 may be, for example, a thin copper or copper alloy tape that has the carbon nanotubes embedded therein and/or deposited thereon, or may simply be carbon nanotubes that are adhered or embedded into an exterior surface of the metal core 116. In some embodiments, the metal coating/plating 117 may comprise two separate metal tapes, the first of which is bonded along the longitudinal length of the top half of the copper/copper alloy wire core 116, and the second of which is bonded along the longitudinal length of the bottom half of the copper/copper alloy wire core 116 so that the two tapes may substantially or completely surround the copper/copper alloy wire core 116.

Referring to FIG. 2, in some embodiments, the conductors 101-108 may be manufactured so that the carbon nanotubes have enhanced alignment along at least one direction (i.e., the carbon nanotubes have a preference to generally align to be parallel to the x-axis, but may be randomly aligned with respect to the y-axis and the z-axis). In some embodiments, the carbon nanotubes may have enhanced alignment along two directions so that the carbon nanotubes have a preference to generally align along the axis of the wire core 116. It will be appreciated that since the wire core 116 may be a twisted, the alignment will be in a direction generally parallel to the axis of the helix defined by the twisted core. Techniques for aligning carbon nanotubes are known in the art and hence will not be discussed further herein. When metal tapes are used to form the coating/plating 117, the metal tape(s) may be welded to the exterior of the wire core 116 by, for example, bringing the carbon nanotube containing metal tape 117 and the wire core 116 together while heating the metal tape 117 and/or the wire core 116 to a temperature that is sufficient to at least partially melt a surface of the metal tape 117 and an exposed surface of the wire core 116 so that the two materials coalesce to have a common crystallographic structure. Various carbon nanotube enhanced communication cables are disclosed in U.S. patent application Ser. No. 13/446,728 (“the '728 application”), filed Apr. 13, 2012, the entire content of which is incorporated herein by reference. Any of the communication cables disclosed in the '728 application may be designed to include the thermally conductive cable jackets, insulative sheaths and/or separators as discussed herein.

The above-described carbon-nanotube enhanced conductors may exhibit substantially improved conduction of high frequency communications signals. As noted above, a high frequency signal will tend to congregate on the exposed surface(s) of the conductor. By providing carbon nanotubes to an appropriate depth (e.g. 50-250 microinches) into the outer surface of the conductor 101-108, substantially improved conductivity may be achieved at high frequencies. Moreover, by manufacturing the metal sheet/tape 117 so that the carbon nanotubes have a preference to be aligned along the axial direction of the conductor, the conductivity may be further enhanced. Such alignment of the carbon nanotubes may also be performed in coated and/or plated embodiments.

Since the carbon nanotube enhanced conductors 101-108 may exhibit significantly less attenuation when carrying high frequency signals, it may be possible to reduce the overall diameter of each conductor 101-108 while still meeting, for example, industry standardized performance criteria. By way of example, small, 24 gauge wires (20 millimeter diameter) may be used to form the conductive cores 115. The use of small wires may significantly reduce both the size and weight of the communications cable 100, and may also advantageously reduce the amount of materials required to manufacture the cable 100, as scaling down of each conductive core 115 allows reductions in the size of the insulative sheaths 118, the separator 110 and the cable jacket 120. However, the use of such small diameter (e.g., 24 gauge) conductors 101-108 may increase the resistance of the cable 100 to direct current and low frequency signals, since the current travels through a smaller volume of material. This increased resistance may cause the cable 100 to heat up during use to the point that the operating temperature of the cable 100 can exceed the maximum design temperature. This can, for example, negatively impact various electrical performance characteristics of the cable 100 that may degrade at higher temperatures. Thus, while the use of carbon nanotubes may allow for excellent high frequency performance even when using smaller diameter conductors 101-108, the use of such smaller diameter conductors 101-108 may be problematic with respect to low frequency and direct current signals. This is particularly true when the communications cable 100 is included in a bundle of cables, as is common practice during the installation of Ethernet cables. In particular, when the cable 100 is in a center of a bundle of cables, the surrounding cables may severely hamper dissipation of heat from the cable 100, which may make it more likely that the cable 100 reaches temperatures that exceed its maximum design temperature.

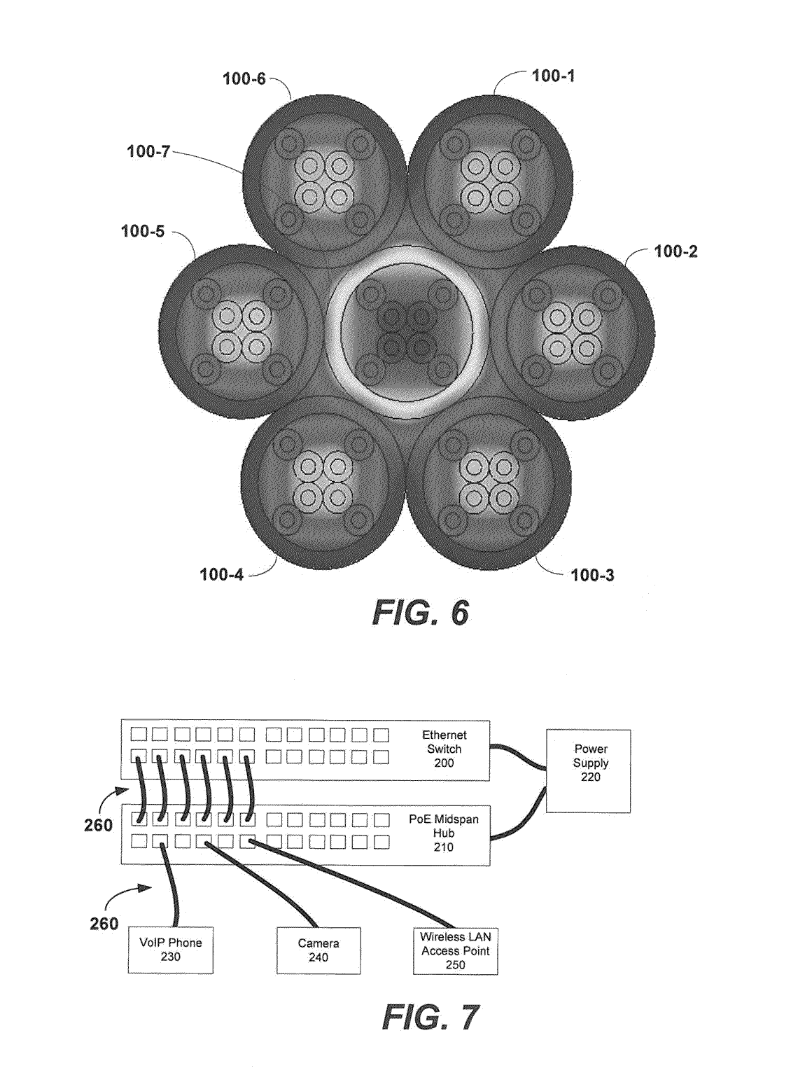

For example, FIG. 6 is a schematic cross-sectional view taken along the longitudinal axis of a bundle of the cables 100, which are labeled as cables 100-1 through 100-7 in FIG. 6. As shown, each cable 100 in FIG. 6 includes four twisted pairs of conductors. One of the cables (cable 100-7) is generally surrounded by the other six cables 100. As shown in FIG. 6 by the different shadings, which represent the temperature of the cable bundle when the cables are being used to transmit signals, the center portion of each cable 100 may be hotter than the outside of each cable 100. Since the six cables 100 on the outside of the cable bundle can dissipate heat to the external environment, they may not tend to exhibit high temperature increases. However, the cable 100-7 that is in the middle of the cable bundle cannot readily dissipate heat to the external environment because it is surrounded by the other six cables 100. Consequently, it will tend to heat up significantly more, with the outside portion of cable 100-7 potentially being heated to higher temperatures than the inside portions of cables 100-1 through 100-6, and with the inside portion of cable 100-7 being heated to even higher temperatures. As such, in operation, cable 100-7 may be heated to temperatures that exceed the design temperature for the cable due to cable bundling. This phenomena is exacerbated as more cables 100 are included in the cable bundles (e.g., in a bundle of 19 cables 100 the middle cable will typically have two other cables interposed between it and the outside of the cable bundle on all sides).

Communications cables may be even more likely to exceed design temperatures when at least some of the cables in a cable bundle carry low frequency signals or carry direct current signals, as is the case in Power-over-Ethernet (“PoE”) applications. FIG. 7 schematically illustrates a PoE application. As shown in FIG. 7, a variety of end devices such as a Voice-over-Internet Protocol (“VoIP”) telephone 230, a network camera 240 and a wireless Local Area Network (“LAN”) access point 250 are connected to an Ethernet network switch 200 via a PoE midspan hub 210. A power supply 220 powers the Ethernet switch 200 and also provides a power signal to the PoE midspan hub 210. A plurality of patch cords 260 connect the end devices 230, 240, 250 to the Ethernet switch 200 via the PoE midspan hub. Each patch cord 260 may comprise, for example, a Category 3, Category 5, Category 5e, Category 6 or Category 6A cable that has four twisted pairs of insulated conductors that may be used to carry information signals between the end devices 230, 240, 250 and the Ethernet switch 200. The patch cords 260 may comprise communications cables according to embodiments of the present invention that include, for example, thermally conductive cable jackets or other structures (e.g., separators) and/or large gauge (small diameter) conductors that, for example, include carbon nanotubes. The PoE midspan hub may inject direct current power signals onto one or more of the twisted pairs of conductors of the patch cords 260 in order to provide a power signal to the end devices 230, 240, 250. As noted above, when such direct current signals are carried on small diameter conductors the electrical resistance of the conductors tends to be higher which results in greater heating. The use of communications cables according to embodiments of the present invention that have thermally conductive cable jackets, separators and/or conductor sheaths may facilitate transferring this extra heat out of the cable and out of the cable bundle.

Pursuant to some embodiments of the present invention, the cable jacket 120 that is included on the communications cable 100 may comprise a thermally conductive cable jacket. For example, the cable jacket 120 may be formed of an insulative material such as a standard insulative jacketing material (e.g., polyethylene, polypropylene, PET, PVC or the like) that has thermally conductive particles dispersed or otherwise embedded therein. These particles may increase the thermal conductivity of the insulative cable jacket material by a factor of two, or five, or ten, one hundred or even five hundred or more. By way of example, insulative materials that are commonly used to form cable jackets may exhibit a very low thermal conductivity of, for example, 0.25 Watts/meter-Kelvin or less. Cable jackets according to embodiments of the present invention may exhibit thermal conductivity of as much as 120 Watts/meter-Kelvin or even more. These thermally conductive cable jackets 120 may be used to more efficiently dissipate heat that may build up in the interior of the cable 100, thus allowing the use of smaller diameter conductors 101-108 while still maintaining acceptable temperature performance, even when the cable 100 is positioned in an interior position within a cable bundle.

In some embodiments, the insulative outer sheath 118 on each of the conductors 101-108 may comprise a thermally conductive insulative sheath 118. Likewise, the separator 110 may also include or comprise thermally conductive materials. This may further facilitate heat transfer from the conductors 101-108 to outside of the cable jacket 120.

The thermally conductive cable jackets, insulative sheaths and/or separators according to embodiments of the present invention may be formed using thermally conductive materials that exhibit electrical isolation and dielectric characteristics that meet or exceed the electrical isolation and dielectric characteristics of conventional cable jackets, insulative sheaths and separators, while providing significantly enhanced thermal conductivity. By way of example, the CoolPoly® D-series of thermally conductive plastics exhibit electrical resistivity in the range of, for example, 10¹² to 10¹⁶ ohm-cm, while exhibiting thermal conductivity of about 1.0 Watt/meter-Kelvin to about 10 Watt/meter-Kelvin, which is about 5 to 100 times the thermal conductivity of conventional plastics. These materials may be purchased in pellet form so that they are suitable for use in standard extrusion operations that are used to form communications cables.

It will also be appreciated that heat transfer and thermal conductivity are not linearly related. In particular, heat transfer has three modes: conduction, convection and radiation. The conduction mode is dependent on the thermal conductivity of the material. Convection and radiation are not. For example, if heat moves through a structure faster than it can be removed from the surface of the structure then increasing the thermal conductivity of the structure will not result in a linear decrease in temperature.

Examples of electrically insulating fillers that can be used, for example, as thermally conductive fillers to improve the thermal conductivity of a cable jacket, insulative sheath or separator include aluminum nitride, hexagonal boron nitride, diamond, graphite, glass, other ceramics, metal flakes (e.g., aluminum), metallized glass fibers, and various polymer based materials. In some embodiments, raw or coated carbon fibers or raw or coated carbon nanotubes may be used as a thermally conductive filler. In some embodiments, high aspect ratio fillers (e.g., aspect ratios greater than five or aspect ratios greater than 10) may be used to improve the thermal conductivity. In selecting suitable materials, the impact of the materials on other characteristics of the cable jacket (or other structure) such as its strength, stiffness, friction and/or cost may be considered to arrive at a cable jacket design that is suitable for each intended application.

The communications cables according to embodiments of the present invention may include a single layer cable jacket or a multi-layer cable jacket. For example, in some embodiments, the cable jacket may comprise a dual layer jacket that includes a conventional (but thinner) inner cable jacket and an outer cable jacket formed of a thermally conductive material. In other embodiments, the positions of the inner and outer jackets may be reversed (i.e., the thermally conductive jacket is the inner jacket). In other embodiments, more than two layers may be employed so that the cable jacket could include thermally conductive materials.

In some embodiments, the cable jacket 120 may include a plurality of internal fins, serrations or the like such as the internal fins illustrated in U.S. Pat. No. 5,796,046, titled Communications Cable Having Striated Cable Jacket, the entire contents of which are incorporated herein by reference. Different shaped internal fins may be used, including fins that are spaced apart from each other so that fewer total fins may be included on the interior surface of the cable jacket. These internal fins or serrations may increase the distance between the conductors 101-108 of two adjacent cables 100 in a cable bundle, thereby reducing the alien crosstalk therebetween.

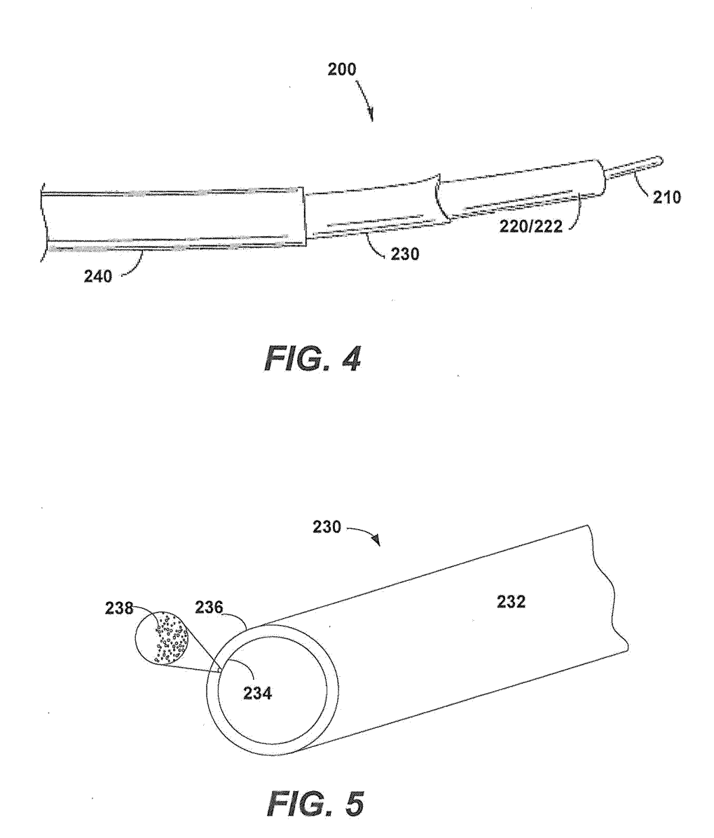

While the above description focuses on twisted pair communications cables, the techniques according to the present inventive concepts may also be used in other types of communications cables. By way of example, FIG. 4 is a side view of a coaxial cable 200 according to embodiments of the present invention. FIG. 5 is a schematic perspective view of the outer conductor of the communications cable 200 of FIG. 4 that illustrates how carbon nanotubes can be embedded within a surface of the conductor.

As shown in FIG. 4, the coaxial cable 200 includes a central conductor 210 that is surrounded by a dielectric 220. A tape 222 may be preferentially bonded to the dielectric 220. An outer conductor 230 that acts as a return conductor and as an electrical shield surrounds the dielectric 220 and the tape 222. One or more optional electrical shielding tapes (not shown) may surround the outer conductor 230. The outer conductor 230 may be corrugated in order to improve overall cable flexibility. A cable jacket 240 (or other insulative protective layer such as, for example, an enamel coating, such coating/protective layers comprising a “cable jacket” as that term is used in the present disclosure) may surround the outer conductor 230 and any electrical shielding tapes.

FIG. 5 is an enlarged view of the outer conductor 230 of the cable 200. As shown in FIG. 5, the outer conductor 230 may comprise a metal sheet 232 that is formed into an annular shape so as to have an inner surface 234 and an outer surface 236. The metal sheet 232 may comprise, for example, a copper sheet or a copper alloy sheet. A plurality of carbon nanotubes 238 may be deposited, coated, embedded or the like onto and/or into at least the inner surface 234 of the metal sheet 232. Such a plurality of carbon nanotubes 238 are graphically illustrated as being provided at the inner surface of the metal sheet 232 in the callout provided in FIG. 5. As shown in the callout, in some embodiments, the carbon nanotubes 238 may only be provided in the surface region of the outer conductor 230. These carbon nanotubes 238 may, in some embodiments, be more aligned along the axis defined by the central conductor 210 than in other directions. While not shown in FIG. 5, carbon nanotubes 238 may also be embedded in or coated on the outer surface 236 of the outer conductor 230 as well, or may extend throughout the entirety of the metal sheet 232.

In some embodiments (and particularly in embodiments that use larger gauge wires for the central conductor), the central conductor 210 may have a hollow central region. In such embodiments, the central conductor 210 may appear identical (except in diameter) to the outer conductor 210 depicted in FIG. 5. As with the outer conductor 210 depicted in FIG. 5, such an annular central conductor 210 may have carbon nanotube containing metal sheet(s) bonded to at least one of the exposed surfaces of the central conductor 210 (i.e., to its inner and/or outer surface).

While the present invention is described above with reference to drawings that illustrate preferred embodiments thereof, it will be appreciated that the present invention may be embodied in many different forms and should not be construed as limited to the embodiments set forth herein. Instead, these embodiments are provided so that this disclosure will be thorough and complete, and will fully convey the scope of the invention to those skilled in the art.

In the drawings, the size of lines and elements may be exaggerated for clarity. It will also be understood that when an element is referred to as being “coupled” to another element, it can be coupled directly to the other element, or intervening elements may also be present. In contrast, when an element is referred to as being “directly coupled” to another element, there are no intervening elements present. Likewise, it will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items. It will also be appreciated that all of the disclosed embodiments may be combined in any way to provide a plurality of additional embodiments.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A communications cable, comprising:
a plurality of insulated conductors that are arranged as four twisted pairs of insulated conductors;
a cable jacket that surrounds the four twisted pairs of insulated conductors, the cable jacket including an outer surface that defines the exterior surface of the communications cable,
wherein the cable jacket is a thermally conductive cable jacket.

2. The communications cable of claim 1, wherein at least some of the insulated conductors comprise an elongated metal wire having a plurality of carbon nanotubes at an exterior surface thereof.

3. The communications cable of claim 2, wherein the cable jacket comprises an insulative material that has thermally conductive materials embedded therein.

4. The communications cable of claim 2, wherein the communications cable is bundled together with a plurality of additional communications cables in a communications cable bundle.

5. The communications cable of claim 2, further comprising a conductive shield that at least partially surrounds one or more of the twisted pairs of insulated conductors, the conductive shield being within the interior of the cable jacket.

6. The communications cable of claim 2, wherein the cable jacket has a thermal conductivity of at least 1 Watt per meter-Kelvin.

7. The communications cable of claim 2, wherein the conductors have a diameter that is no greater than 21 millimeters.

8. The communications cable of claim 2, wherein the metal wire comprises a copper wire, a copper alloy wire, a copper plated wire or a copper alloy plated wire.

9. The communications cable of claim 8, wherein an axial direction of a majority of the carbon nanotubes is generally aligned with a longitudinal axis of the elongated metal wire.

10. The communications cable of claim 1, wherein the cable further comprises a separator that separates at least a first twisted pair of insulated conductors from a second twisted pair of insulated conductors, wherein the separator is a thermally conductive separator.

11. The communications cable of claim 1, wherein the insulation on at least some of the insulated conductors comprise thermally conductive insulation.

12. A communications cable, comprising:
at least one metal conductor that includes carbon nanotubes; and
a thermally conductive cable jacket that surrounds the at least one metal conductor and that defines the exterior surface of the communications cable.

13. The communications cable of claim 12, wherein the at least one metal conductor comprises the center conductor of a coaxial cable, the communications cable further comprising a dielectric layer that surrounds the center conductor and an outer conductor that surrounds the dielectric layer, the outer conductor being within the thermally conductive cable jacket.

14. The communications cable of claim 12, wherein the outer conductor comprises an elongated hollow metal wire having a plurality of carbon nanotubes embedded in an exposed surface thereof.

15. The communications cable of claim 12, wherein the dielectric layer includes thermally conductive particles embedded therein.

16. The communications cable of claim 12, wherein the thermally conductive cable jacket is electrically insulative.

17. A communications cable, comprising:
a plurality of insulated conductors that are arranged as four twisted pairs of insulated conductors;
a thermally conductive and electrically insulative cable jacket that surrounds the four twisted pairs of insulated conductors, the cable jacket including an outer surface that defines the exterior surface of the communications cable; and
a thermally conductive separator that separates at least a first of the twisted pairs of insulated conductors from a second of the twisted pairs of insulated conductors.

18. The communications cable of claim 17, wherein the insulation on at least some of the insulated conductors comprise thermally conductive insulation.

19. The communications cable of claim 18, wherein at least some of the insulated conductors comprise an elongated metal wire having a plurality of carbon nanotubes at an exterior surface thereof.

20. The communications cable of claim 19, wherein the communications cable is bundled together with a plurality of additional communications cables in a communications cable bundle.

21. The communications cable of claim 16, in combination with a direct current power source that is configured to provide a direct current power signal to at least a first of the insulated conductors.
